(19) United States
(12) Patent Application Publication
(10) Pub. No.: US 2015/0233513 A1
(43) Pub. Date: Aug. 20, 2015

(54) CONDUIT BODY WITH OFF-SET OPENINGS

(71) Applicant: Andrew K. Grabowski, Cheektowaga, NY (US)

(72) Inventor: Andrew K. Grabowski, Cheektowaga, NY (US)

(21) Appl. No.: 14/704,172

(22) Filed: May 5, 2015

(51) Int. Cl. F16L 41/02

(52) U.S. Cl. CPC F16L 41/02

(57) ABSTRACT

A conduit body, including: a body portion formed of only one single piece of material; a first axis passing through the body portion; a first opening through which the first axis passes; a second axis passing through the body portion, orthogonal to the first axis and off-set from the first axis; and a second opening through which the second axis passes. The first opening is arranged to receive a first conduit and the second opening is arranged to receive a second conduit.

### TECHNICAL FIELD

The present disclosure relates generally to a conduit body, in particular, a conduit body with openings off-set to receive respective conduit on off-set planes.

### BACKGROUND

FIG. 6 is side view of a prior art conduit installation. It is a well-known practice, in particular in commercial, institutional, and industrial settings, to install electrical and telecommunications conduit in parallel runs, for example for branch circuits. Branch conduit must be connected to the parallel conduit, for example for other circuits branching from the feeder circuits. Typically, the branch conduit is run perpendicular to the main conduit. However, since the main conduit are all in a same plane, the main conduit from which the branch conduit is to extend must be bent into an offset to place the branch conduit out of the plane of the main conduit. For example, in FIG. 6, conduit C7 is a main conduit. In order to connect branch conduit C8 to main conduit C9 (in the same plane as conduit C7), conduit C9 must be bent into an offset so that conduit body CB and branch conduit C8 can clear conduit C7. Conduit C10, which continues conduit C9, also must be bent into an offset. Bending main conduit to accommodate branch conduit is a time consuming process that increases the cost of electrical or telecommunications system installations.

### SUMMARY

The present disclosure broadly comprises a conduit body, including: a body portion formed of only one single piece of material; a first axis passing through the body portion; a first opening through which the first axis passes; a second axis passing through the body portion, orthogonal to the first axis and off-set from the first axis; and a second opening through which the second axis passes. The first opening is arranged to receive a first conduit and the second opening is arranged to receive a second conduit.

The present disclosure broadly comprises a conduit body, including: a body portion formed of only one single piece of material; a first axis passing through the body portion; a first opening through which the first axis passes and passing through the only one single piece of material and wholly surrounded by the only one single piece of material; a first cylindrical portion formed by the only one single piece of material, forming a portion of the first opening and extending from the body portion in a first axial direction parallel to the first axis; a second axis passing through the body portion, orthogonal to the first axis and off-set from the first axis; a second opening through which the second axis passes and passing through the only one single piece of material and wholly surrounded by the only one single piece of material; a second cylindrical portion formed by the only one single piece of material, forming a portion of the second opening and extending from the body portion in a second axial direction parallel to the second axis. The first and second openings are arranged to receive first and second conduits, respectively.

The present disclosure broadly comprises a conduit body, including: a body portion formed of only one single piece of material; a first axis passing through the body portion; a first and second openings in which the first axis is centered; first and second cylindrical portions formed by the only one single piece of material, forming portions of the first and second openings, respectively and extending from the body portion in first and second opposite axial directions, respectively, parallel to the first axis; a second axis passing through the body portion and orthogonal to the first axis; a third opening in which the second axis is centered; a third cylindrical portion formed by the only one single piece of material, forming a portion of the third opening and extending from the body portion in a third axial direction parallel to the second axis The first and second axis do not intersect. The first, second, and third openings are arranged to receive first, second and third conduits, respectively.

### BRIEF DESCRIPTION OF THE DRAWINGS

The nature and mode of operation of the present disclosure will now be more fully described in the following detailed description of the present disclosure taken with the accompanying figures, in which:

FIG. 1 is a front view of a conduit body with off-set openings;

FIG. 2 is back view of the conduit body shown in FIG. 1;

FIG. 3 is a right-side view of the conduit body shown in FIG. 1;

FIG. 4 is a top view of the conduit body shown in FIG. 1;

FIG. 5 is a view of the conduit body shown in FIG. 1 in a conduit installation; and,

FIG. 6 is side view of a prior art conduit installation.

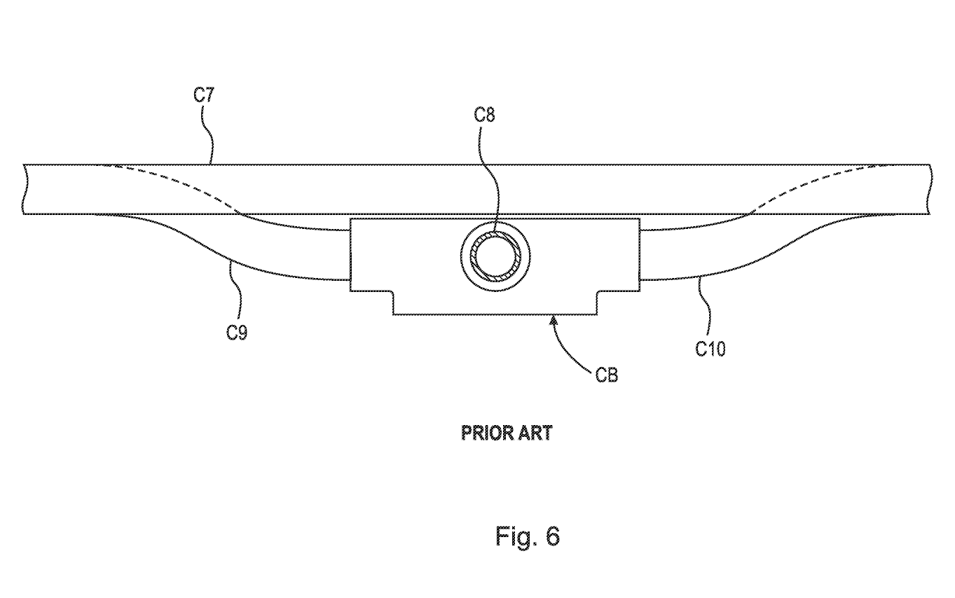

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

Unless defined otherwise, all technical and scientific terms used herein have the same meaning as commonly understood to one of ordinary skill in the art to which this present disclosure belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims.

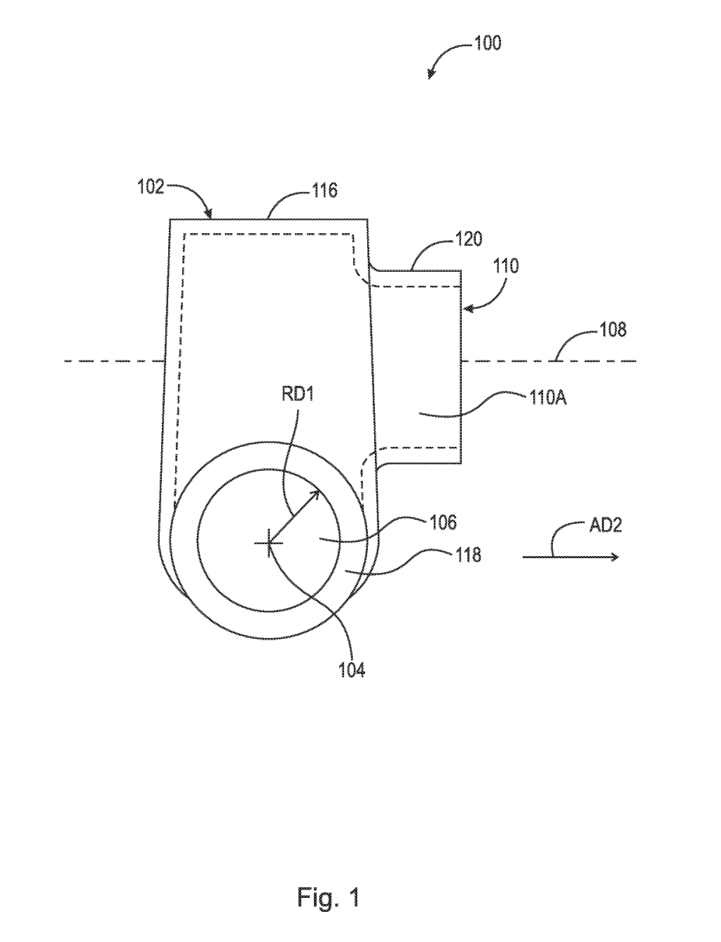

FIG. 1 is a front view of conduit body 100 with off-set openings.

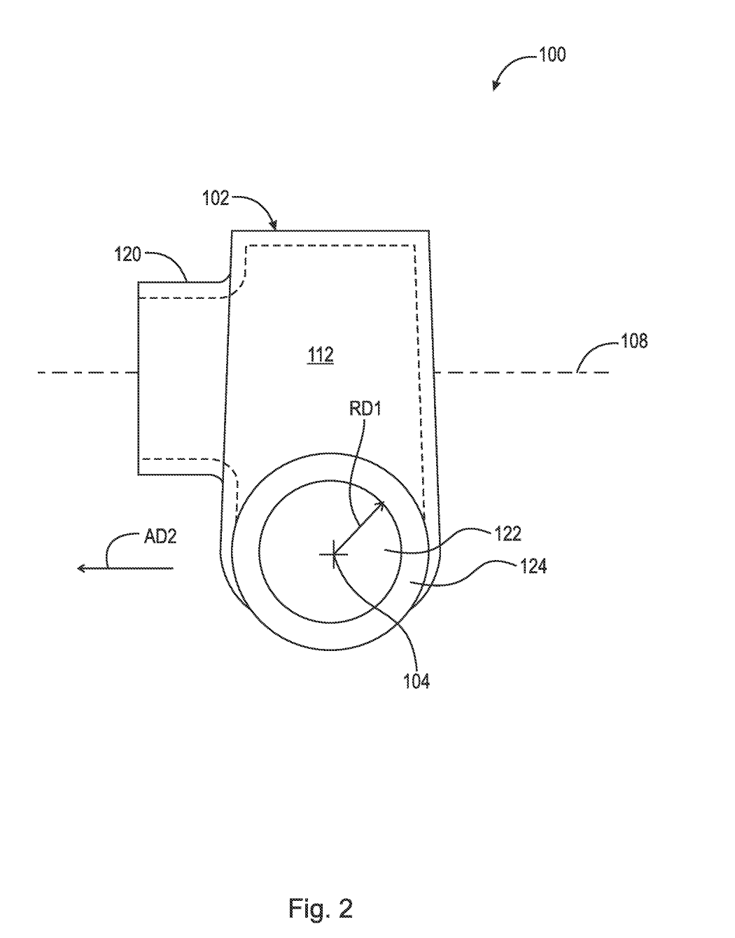

FIG. 2 is back view of conduit body 100 shown in FIG. 1.

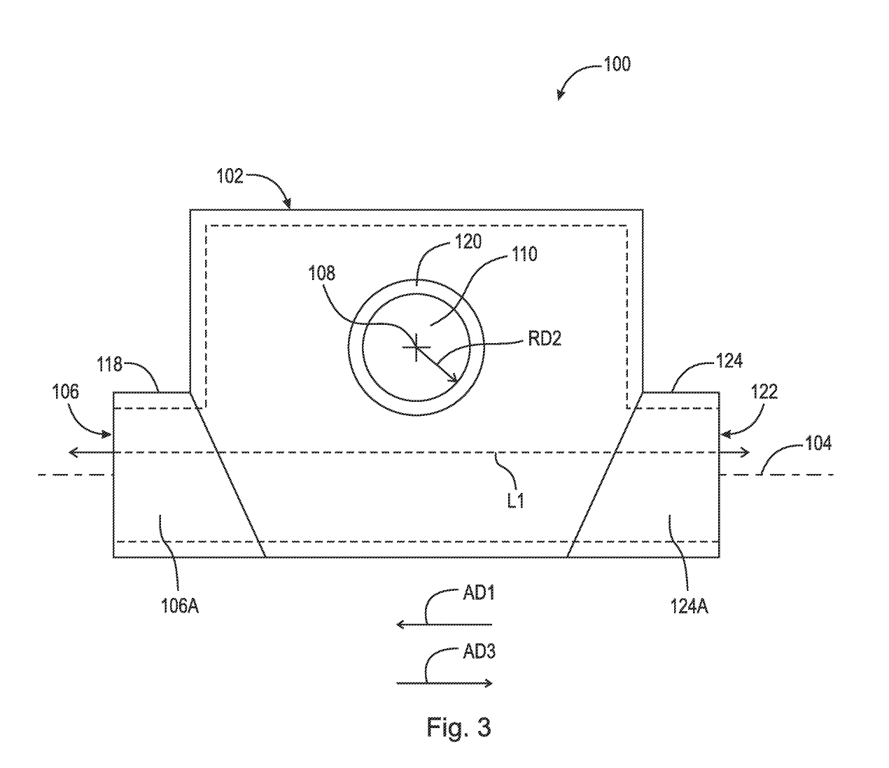

FIG. 3 is a right-side view of conduit body 100 shown in FIG. 1. The following should be viewed in light of FIGS. 1 through 3. Conduit body 100 includes body portion 102, axis 104, opening 106, axis 108, and opening 110. Portion 102 is formed of only one single piece of material 112. Axis 104 passes through body portion 102 and opening 106. Axis 108: is orthogonal to axis 104; is off-set from axis 104; and passes through body portion 102 and opening 110. Openings 106 and 110 are arranged to receive respective conduits (not shown).

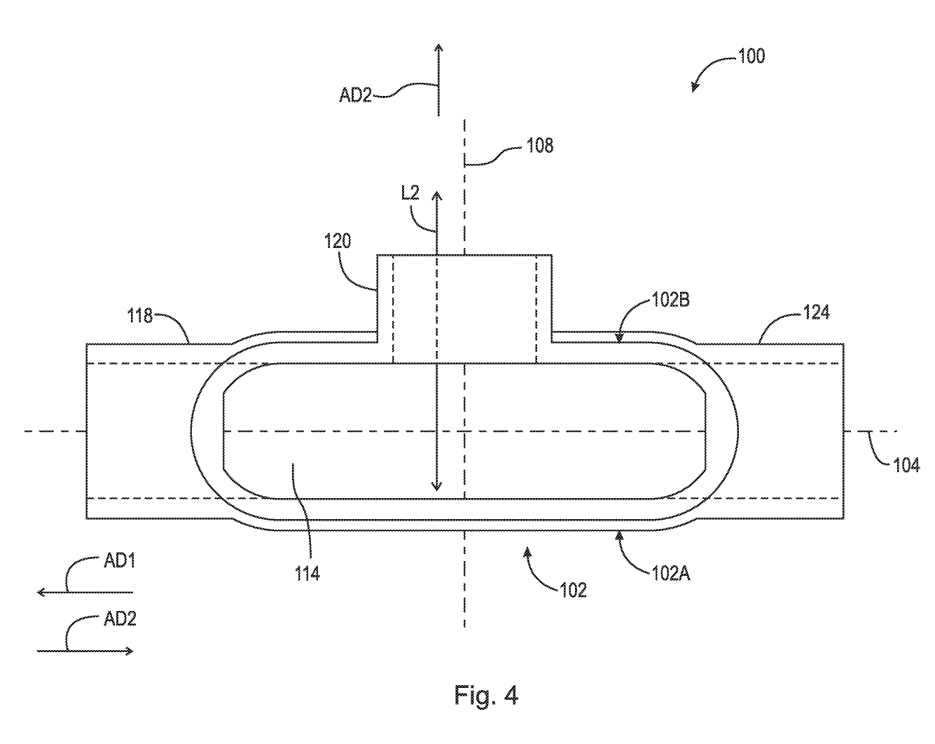

FIG. 4 is a top view of conduit body 100 shown in FIG. 1. The following should be viewed in light of FIGS. 1 through 4. Axis 108 is off-set from axis 104 in radial direction RD1 orthogonal to axis 104. Axis 104 and 108 do not intersect. Opening 106 passes through piece of material 112 and is wholly surrounded by piece of material 112. Opening 110 passes through piece of material 112 and is wholly surrounded by piece of material 112. Cavity 114 is formed by portion 102. Openings 106 and 110 connect cavity 114 to exterior surface 116 of conduit body 102.

Body 100 includes cylindrical portion 118 formed by piece of material 112. Portion 118 surrounds portion 106A of opening 106 in radial direction RD1 and extends from body portion 102 in axial direction AD1 parallel to axis 104. Axis 104 is centered in opening 106 and portion 118 and forms a longitudinal axis for portion 118.

Body 100 includes cylindrical portion 120 formed by piece of material 112. Portion 120 surrounds portion 110A of opening 110 in radial direction RD2, orthogonal to axis 108, and extends from body portion 102 in axial direction AD2 parallel to axis 108. Axis 108 is centered in opening 110 and portion 120 and forms a longitudinal axis for portion 120.

Cylindrical portion 118 forms a segment of body portion 102 extending furthest in the axial direction AD1. Cylindrical portion 120 forms a segment of body portion 102 extending furthest in the axial direction AD2. Cylindrical portions 118 and 120 are arranged to receive the conduits noted above with respect to openings 106 and 110, respectively.

In an example embodiment, conduit body 100 includes opening 122 and cylindrical portion 124. Axis 104 passes through opening 122 and portion 124. Opening 122 passes through piece of material 112 and is wholly surrounded by piece of material 112. Opening 122 connects cavity 114 to exterior surface 116 of conduit body 102. Cylindrical portion 124 is formed by piece of material 112. Portion 124 surrounds portion 124A of opening 122 in radial direction RD1 and extends from body portion 102 in axial direction AD3, opposite axial direction AD1. Axis 104 is centered in opening 122 and portion 124 and forms a longitudinal axis for portion 124. Opening 122 is arranged to receive a conduit. (not shown).

Body portion 102 includes: segment 102A including openings 106 and 122; and segment 102B including opening 110. In an example embodiment, segment 102A extends beyond segment 102B in axial directions AD1 and AD3.

In an example embodiment, no line, such as line L1, parallel to axis 104 and passing through opening 106, intersects any line, such as line L2, parallel to axis 108 and passing through opening 110. Stated otherwise, openings 106/122 and 110 are wholly off-set from each other.

A cover (not shown) can be attached to portion 102B to close cavity 114.

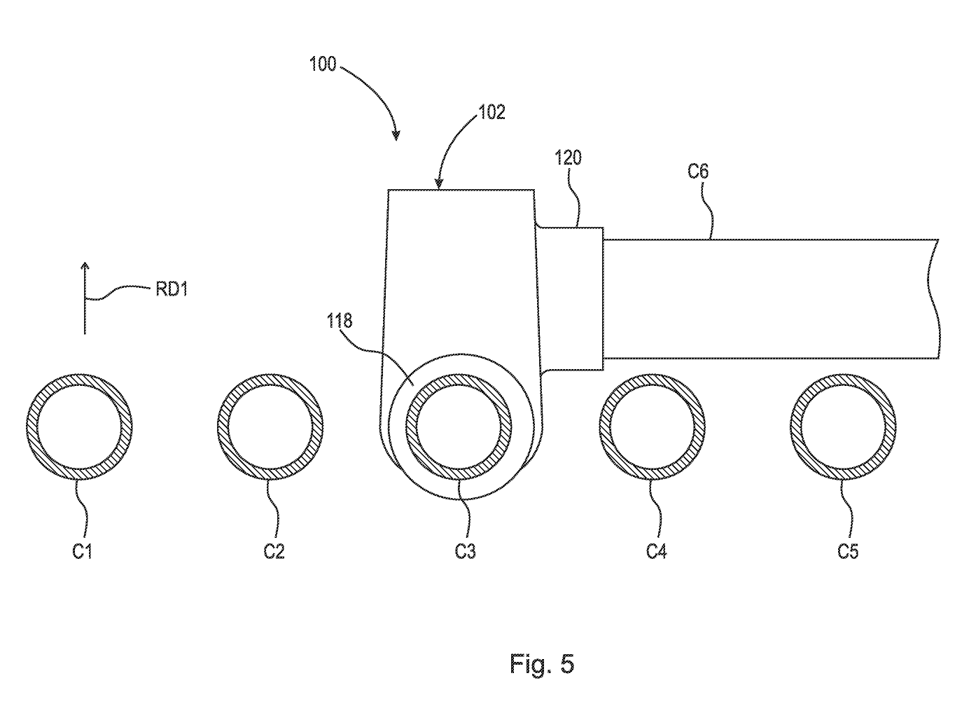

FIG. 5 is a view of conduit body 100 shown in FIG. 1 in a conduit installation. Advantageously, conduit body 100 eliminates the need, noted above, for bending an offset on main conduit to accommodate branch conduit. Conduit C1 through C5 are aligned along a same plan as is typical in the art. Conduit body 100 is attached to conduit C3 to accommodate conduit C6 running orthogonal to conduit C1 through C5. However, since portion 120, receiving conduit C6, is offset from portion 118, receiving conduit C3, in direction RD1, it is not necessary to bend conduit C3 to position conduit body 100 above or below conduit C1 through C5. By eliminating the need to bend conduit, such as conduit C3, the time and cost for installing electrical and telecommunications conduit is greatly reduced.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A conduit body, comprising:
a body portion formed of only one single piece of material;
a first axis passing through the body portion;
a first opening through which the first axis passes;
a second axis:
passing through the body portion;
orthogonal to the first axis; and,
off-set from the first axis; and, a second opening through which the second axis passes, wherein:
the first opening is arranged to receive a first conduit; and,
the second opening is arranged to receive a second conduit.

2. The conduit body of claim 1, wherein the second axis is off-set from the first axis in a radial direction orthogonal to the first axis.

3. The conduit body of claim 1, wherein the first and second axis do not intersect.

4. The conduit body of claim 1, wherein:
the first opening passes through the only one single piece of material and is wholly surrounded by the only one single piece of material; and,
the second opening passes through the only one single piece of material and is wholly surrounded by the only one single piece of material.

5. The conduit body of claim 1, further comprising:
a first cylindrical portion:
formed by the only one single piece of material;
surrounding a portion of the first opening in a first radial direction orthogonal to the first axis; and,
extending from the body portion in a first axial direction parallel to the first axis; and,
a second cylindrical portion:
formed by the only one single piece of material;
surrounding a portion of the second opening in a second radial direction orthogonal to the second axis; and,
extending from the body portion in a second axial direction parallel to the second axis.

6. The conduit body of claim 5, wherein:
the first cylindrical portion forms a segment of the body portion extending furthest in the first axial direction; and,
the second cylindrical portion forms a segment of the body portion extending furthest in the second axial direction.

7. The conduit body of claim 5, wherein the first and second cylindrical portions are arranged to receive the first and second conduits, respectively.

8. The conduit body of claim 5, further comprising:
a third opening through which the first axis passes; and,
a third cylindrical portion:
formed by the only one single piece of material;
surrounding a portion of the third opening in the first radial direction; and,
extending from the body portion in a third axial direction, opposite the first axial direction, wherein the third ring-shaped portion is arranged to receive a third conduit.

9. The conduit body of claim 1, wherein no first line parallel to the first axis and passing through the first opening intersect any second line parallel to the second axis and passing through the second opening.

10. The conduit body of claim 1, wherein:
the body portion includes:
a first segment including the first opening; and,
a second segment including the second opening; and,
the first segment extends beyond the second segment in the first axial direction.

11. The conduit body of claim 1, wherein the first axis is centered within the first opening.

12. The conduit body of claim 1, wherein the second axis is centered within the second opening.

13. A conduit body, comprising:
a body portion formed of only one single piece of material;
a first axis passing through the body portion;
a first opening:
through which the first axis passes; and,
passing through the only one single piece of material and wholly surrounded by the only one single piece of material;
a first cylindrical portion:
formed by the only one single piece of material;
forming a portion of the first opening; and,
extending from the body portion in a first axial direction parallel to the first axis;
a second axis:
passing through the body portion;
orthogonal to the first axis; and,
off-set from the first axis;
a second opening:
through which the second axis passes; and,
passing through the only one single piece of material and wholly surrounded by the only one single piece of material;
a second cylindrical portion:
formed by the only one single piece of material;
forming a portion of the second opening; and,
extending from the body portion in a second axial direction parallel to the second axis, wherein the first and second openings are arranged to receive first and second conduits, respectively.

14. The conduit body of claim 13, wherein no first line parallel to the first axis and passing through the first opening intersect any second line parallel to the second axis and passing through the second opening.

15. The conduit body of claim 13, wherein:
the body portion includes:
a first segment including the first opening; and,
a second segment including the second opening;
the first segment extends beyond the second segment in the first axial direction;
a first direction passes through the first and second axis and extends from the first axis to the second axis; and,
the second segment extends past the first segment in the first direction.

16. The conduit body of claim 13, wherein:
the first cylindrical portion forms a first segment of the body portion extending furthest in the first axial direction; and,
the second cylindrical portion forms a segment of the body portion extending furthest in the second axial direction.

17. The conduit body of claim 13, further comprising:
a third opening through which the first axis passes; and,
a third cylindrical portion:
formed by the only one single piece of material;
forming a portion of the third opening; and,
extending from the body portion in a third axial direction, opposite the first axial direction, wherein the third ring-shaped portion is arranged to receive a third conduit.

18. A conduit body, comprising:
a body portion formed of only one single piece of material;
a first axis passing through the body portion;
a first and second openings in which the first axis is centered;
first and second cylindrical portions:
formed by the only one single piece of material;
forming portions of the first and second openings, respectively; and,
extending from the body portion in first and second opposite axial directions, respectively, parallel to the first axis;
a second axis:
passing through the body portion; and,
orthogonal to the first axis;
a third opening in which the second axis is centered;
a third cylindrical portion:
formed by the only one single piece of material;
forming a portion of the third opening;
extending from the body portion in a third axial direction parallel to the second axis, wherein:
the first and second axis do not intersect; and,
the first, second, and third openings are arranged to receive first, second and third conduits, respectively.

19. The conduit body of claim 18, wherein no first line parallel to the first axis and passing through the first and second openings intersect any second line parallel to the second axis and passing through the third opening.

20. The conduit body of claim 18, wherein:
the first and second cylindrical portions form segments of the body portion extending furthest in the first and second axial directions, respectively; and,
the second cylindrical portion forms a segment of the body portion extending furthest in the third axial direction.
